(19) United States
(12) Patent Application Publication
(10) Pub. No.: US 2018/0290468 A1
(43) Pub. Date: Oct. 11, 2018

(54) PROGRESSIVE BUFFER GENERATION

(71) Applicant: HEWLETT-PACKARD DEVELOPMENT COMPANY, L.P., Houston, TX (US)

(72) Inventors: Eduardo Martin ORUE, Sabadell (ES); Marta Ramis LLINARES, Cerdanyola del Valles (ES); Fco Javier Roses CONESA, Sant Quirze del Valles (ES)

(73) Assignee: Hewlett-Packard Development Company, L.P., Houston, TX (US)

(21) Appl. No.: 15/522,114

(22) PCT Filed: Nov. 12, 2014
(86) PCT No.: PCT/US2014/065307

§ 371 Date: Apr. 26, 2017

(51) Int. Cl. B41J 15/16; B41J 29/38

(52) U.S. Cl. CPC B41J 15/16; B41J 29/38

(57) ABSTRACT

Example implementations relate to progressive buffer generation. Some examples may include a drive system to advance print media through a print zone at a printing speed and a buffer speed calculation system to calculate a buffer generation speed based on the printing speed, a length of a plot to be printed, a minimum buffer, a buffer start position and an amount of time required to cut the print media. Some examples may also include a buffer generation system to generate a buffer between the buffer generation system and the drive system. In some examples, the buffer may be generated by advancing the print media at the buffer generation speed to accumulate a portion of the print media between the drive system and the buffer generation system.

### BACKGROUND

A printing device, such as a printer, multifunction printer, or the like, may be used to print content onto print media. While some printing devices may accept the print media in a single sheet format, others accept print media fed from a supply roll. These printing devices may be referred to as roll-based printers. In some roll-based printers, the feeding of print media from a roll may be undertaken by means of a roller that advances the print media while providing some tension (e.g., back-tension) to the media. If the tension is too high, the print media can slip from the traction of the roller, causing deterioration in print quality in the form of a distorted image.

### BRIEF DESCRIPTION OF THE DRAWINGS

The following detailed description references the drawings, wherein:

FIG. 1A is a block diagram of an example printing system for progressive buffer generation consistent with disclosed implementations;

FIG. 1B is a block diagram or an example buffer speed calculation system for progressive buffer generation consistent with disclosed implementations;

FIG. 2 is a simplified illustration of an example printing system for progressive buffer generation consistent with disclosed implementations;

FIG. 3 is a flow chart of an example process for progressively generating a buffer consistent with disclosed implementations; and

FIG. 4 is a flow chart of an example process for calculating a buffer generation speed consistent with disclosed implementations.

### DETAILED DESCRIPTION

The following detailed description refers to the accompanying drawings. Wherever possible, the same reference numbers are used in the drawings and the following description to refer to the same or similar parts. While several examples are described in this document, modifications, adaptations, and other implementations are possible. Accordingly, the following detailed description does not limit the disclosed examples Instead, the proper scope of the disclosed examples may be defined by the appended claims.

As detailed above, roll-based printers may print on roll-based media. In some roll-based printers, the roll-based media may be cut during or after printing to create a single printed sheet. To more stably control the feed rate of the roll-based printer, a buffer may be generated by collecting an amount of print media prior to the cutting. For example, at a static predetermined point in the printing process (e.g., 200 mm before the end of the print) these roll-based printers may advance the media at a static predetermined speed (e.g., the maximum printer speed) to generate enough buffer to cut. Thus, there may be some portions of the printing process where there is no buffer at ail (which may create media tension) and other portions where the buffer starts to be generated (which may create media tension and change in the advance direction of the print media). This media tension and change in the advance direction of the print media may create image quality defects. Accordingly, to achieve consistent print quality, it is important to be able to generate a buffer in a manner that reduces or eliminates media tension and/or does not substantially alter the direction of movement of the print media.

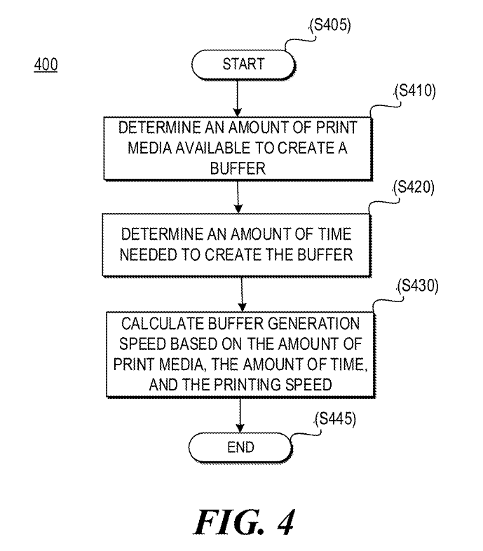

Examples disclosed herein may provide buffer generation in a manner that reduces or eliminates media tension and/or does not substantially alter the direction of movement of the print media. To this end, example implementations disclosed herein may provide progressive buffer generation. For example, instead of generating the buffer at a static predetermined speed, such as the maximum speed of a roller, examples consistent with disclosed implementations may generate a buffer based on a calculated buffer generation speed. The buffer generation speed may be calculated by a buffer speed calculation system, and may be based on a printing speed, a length of a plot to be printed, a minimum buffer (e.g., a minimum amount of buffer needed after cutting to isolate the print zone from media tension), a buffer start position (e.g., a position on the print media where buffer generation system 130 starts generating the buffer), and/or an amount of time required to cut the print media. For example, the buffer generation speed may be calculated by adding the printing speed to ex feed speed (described in detail below with respect to FIG. 4) needed to generate the buffer. Furthermore, in some examples, the buffer start position may be calculated and/or modified based on a length of the plot to be printed. Additionally, in some examples, instead of waiting for a particular point in a plot to generate a buffer, the buffer may be progressively generated such that when the print media arrives at the print zone, at least a portion of the buffer has already been generated. For example, the portion of the buffer that has already been generated may correspond with the minimum buffer. By ensuring that there is a minimum buffer, some examples may control the tension in the print media and changes in media direction during the printing process.

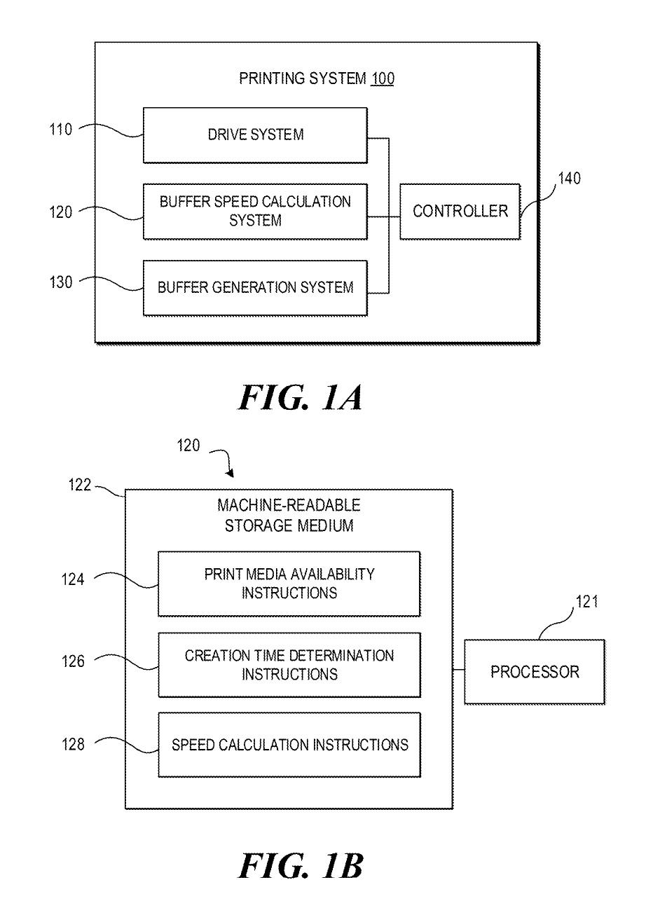

Referring now to the drawings, FIG. 1A is a block diagram of an example printing system 100 for progressive buffer generation consistent with disclosed implementations. Printing system 100 may be implemented in various ways. For example, printing device 100 may be a roll-based printer, a computing system, and/or any other type of suitable device or system that can produce content (e.g. images, text, etc.) on a print medium. In the example shown in FIG. 1A, printing system 100 may include a drive system 110, a buffer speed calculation system 120, a buffer generation system 130, and a controller 140.

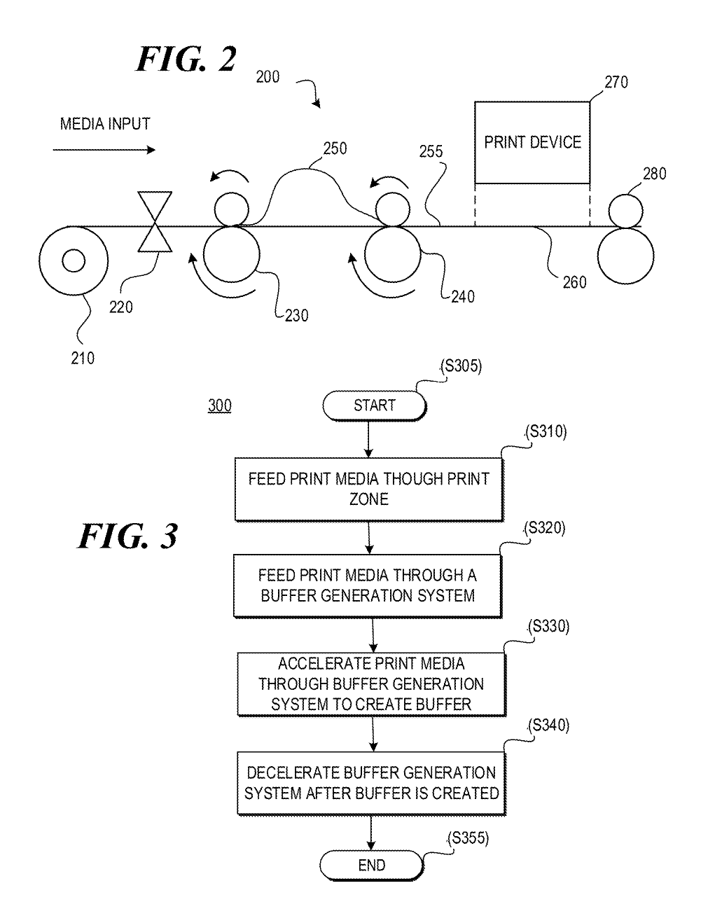

Drive system 110 may be any component or collection of components that advances print media through a print zone. For example, drive system 110 may include components such as at least one roller (e.g., a drive roller), star wheel, drum, belt, and/or the like to advance the print media at a printing speed. In some implementations, drive system 110 may be positioned upstream from the print zone and may use the component(s) to engage the print media and push the print media towards the print zone. For example, drive system 110 may continuously advance a first portion of the print media at the printing speed while the buffer generation system advances a second portion of the print media at the buffer generation speed. Thus, drive system 110 may continuously advance the print media through the print zone such that content is applied to the print media while the print media is moving. Examples of the processes performed by drive system 110 are discussed in greater detail below with respect to, for example, FIGS. 2-4.

Buffer speed calculation system 120 may be any component or collection of components that calculate a buffer generation speed. For example, buffer speed calculation system 120 may be component(s) that calculate a buffer generation speed based on the printing speed, a length of a plot to be printed, a minimum buffer, a buffer start position, and an amount of time required to cut the print media. In some implementations, buffer speed calculation system 120 may be electronic circuitry for implementing functionality consistent with disclosed implementations. For example, buffer speed calculation system 120 may be a machine-readable storage medium encoded with instructions which, when executed by a processor, calculate the buffer generation speed. In some examples, the buffer speed calculation system may calculate the buffer generation speed such that when the print media arrives at the print zone, the minimum buffer has already been generated. Examples of buffer speed calculation system 120 and the processes performed by buffer speed calculation system 120 are discussed in greater detail below with respect to, for example, FIGS. 1B-4.

Buffer generation system 130 may be any component or collection of components that progressively (e.g. gradually) generates a buffer. For example, buffer generation system 130 may include components such as at least one roller (e.g., a feed roller), star wheel, drum, belt, and/or the like to generate a buffer between buffer generation system (e.g., the at least one roller) and drive system 110 using the buffer generation speed calculated by buffer speed calculation system 120. In some examples, buffer generation system 130 may be positioned upstream from both the print zone and drive system 110. Additionally, in some implementations, buffer generation system may generate the buffer by advancing the print media at the buffer generation speed to accumulate a portion of the print media between drive system 110 and buffer generation system 130. For example, buffer generation system may advance the print media such that at least a portion of the buffer has been generated when the print media arrives at the print zone. In some examples, the buffer generation system may generate a buffer between the entry of the buffer generation system and the drive system. Examples of the processes performed by buffer generation system 130 are discussed in greater detail below with respect to, for example, FIGS. 2-4.

Controller 140 may be am component or collection of components to coordinate drive system 110, buffer speed calculation system 120, and/or buffer generation system 130. For example, controller 140 may be at least one processing unit (CPU), microprocessor, and/or another hardware device to execute instructions to perform operations. For example, controller 140 may fetch, decode, and execute processing instructions stored in a non-transitory machine-readable storage medium to perform operations related to disclosed examples. In some implementations, controller 140 may coordinate a speed of buffer generation system 130. For example, controller 140 may coordinate a speed of buffer generation system 130 by controlling buffer generation system 130 to advance the print media at the buffer generation speed when the buffer start position arrives at buffer generation system 130. As another example, controller 140 may coordinate a speed of buffer generation system 130 by stopping buffer generation system 130 when the buffer reaches a particular size (e.g., a size equal to the sum of the minimum buffer and the required additional buffer). Examples of the processes performed by controller 140 are discussed in greater detail below with respect to, for example, FIGS. 1B-4.

FIG. 1B is a block diagram of an example buffer speed calculation system 120 for progressive buffer generation consistent with disclosed implementations. In some implementations, buffer speed calculation system 120 of FIG. 1B may correspond with buffer speed calculation system 120 of FIG. 1A. As discussed above, buffer speed calculation system 120 may be implemented in various ways, such as by electronic circuitry or a combination of electronic circuitry and programming. In the example shown in FIG. 1, buffer speed calculation system may include a machine-readable storage medium 122 and optionally processor 121.

Processor 121 may be at least one processing unit (CPU), microprocessor and/or another hardware device to execute instructions to perform operations. For example, processor 121 may fetch, decode, and execute instructions to calculate a buffer generation speed (e.g., instructions 124, 126, and/or 128) stored in machine-readable storage medium 122 to perform operations related to disclosed examples. While FIG. 1B shows processor 121 as being separate and distinct from controller 140, in some examples processor 12 may be part of or entirely constitute controller 140.

Machine-readable storage medium 122 may be any electronic, magnetic, optical, or other physical storage device that stores executable instructions. Thus, machine-readable storage medium 122 may be, for example, Random Access Memory (RAM), Electrically-Erasable Programmable Read-Only Memory (EEPROM), a storage drive, an optical disc, and the like. In some implementations, machine-readable storage medium 122 may be a non-transitory computer-readable storage medium, where the term “non-transitory” does not encompass transitory propagating signals. Machine-readable storage medium 122 may be encoded with instructions that, when executed processor 121, perform operations consistent with disclosed implementations. For example, machine-readable storage medium 122 may include image processing instructions that perform operations that may calculate a buffer generation speed. In the example shown in FIG. 1B, machine-readable storage medium 122 may include print media availability instructions 124, creation time determination instructions 126, and speed calculation instructions 128.

Print media availability instructions 124 may function to determine an amount of print media available to create a buffer. For example, when print media availability instructions 124 are executed by a processor, such as processor 121 of buffer speed calculation system 120, print media availability instructions 124 may cause processor 121 and/or another processor to determine an amount of media available to create a buffer between the buffer start position and a drive system, such drive system 110. In some implementations, the amount of media may be based on a plot length, and may be greater than or equal to a minimum buffer and less than or equal to a maximum buffer (e.g., a buffer size that may correspond with a maximum buffer that will fit inside a print device associated with the print zone). Additionally in some implementations the drive system 110 may be a system that continually advances the print media at a printing speed through a print zone. Examples of these determinations are described in further detail below with respect to, for example, FIG. 4.

Creation time determination instructions 126 may function to determine an amount of time needed to create the buffer. For example, when creation time determination instructions 126 are executed by a processor, such as processor 121 of buffer speed calculation system 120, creation time determination instructions 126 may cause the processor to determine an amount of time needed to create the buffer based on one or more of the amount of print media available to create the buffer, the printing speed, and an amount of time required to decelerate and/or accelerate the print media up to printing speed, and the time required to cut the media. Examples of these determinations are described in further detail below with respect to, for example, FIG. 4.

Speed calculation instructions 128 may function to calculate a buffer generation speed. For example, when speed calculation instructions 128 are executed by a processor, such as processor 121 of buffer speed calculation system 120, speed calculation instructions 128 may cause processor 121 and/or another processor to calculate the buffer generation speed based on the printing speed, the amount of print media available to create the buffer, and the amount of time needed to create the buffer. Examples of this calculation are described in further detail below with respect to, for example, FIG. 4.

The arrangements illustrated in FIGS. 1A and 1B are simply examples, and printing system 100 and its components (such as buffer speed calculation system 120) may be implemented in a: number of different configurations. For example, while FIG. 1A shows one drive system 110, buffer speed calculation system 120, buffer generation system 130, and controller 140, printing system 100 may include any number of components 110, 120, 130, and 140 as well as other components not depicted in FIG. 1A. For example, printing system 100 may omit any of components 110, 120, 130, and 140 and/or combine at least one of components 110, 120, 130, and 140 (e.g., buffer speed calculation system 120 may be combined with controller 140). As another example, while FIG. 1A shows that each of components 110, 120, 130, and 140 communicatively connected, at least one of components, 110, 120 130, and/or 140 not be communicatively connected to other components of printing system 100 or to external components. As yet another example, while FIG. 1A shows that each of components 110, 120, 130, and 140 are internal to printing system 100, at least one of components 110, 120, 130, 140 may be external to printing system 100. For example, buffer speed calculation system 120 may be part of a computing system external to printing system 100.

FIG. 2 is a simplified illustration of an example printing system 200 for progressive buffer generation consistent with disclosed implementations. In certain aspects, printing system 200 may correspond to printing system 100 of FIG. 1A. For example, printing system 200 may perform operations that are the same as or similar to those performed by printing system 100 of FIG. 1A. As shown in FIG. 2, printing system 200 may be operated in a continuous printing mode, in which printing fluid (e.g., ink) is applied to print media (e.g., print media 210) while the print media is continuously moving under a print device (e.g., print device 270). Furthermore, as shown in FIG. 2, printing system 200 may include a cutting system 220 to cut print media 210 after buffer 250 is generated, a feed roller 230 to advance a roll of print media 210 to generate the buffer by accumulating a portion of print media 210 between feed roller 230 and drive roller 240, a drive roller 240 to advance print media 210 through a print zone generated by a print device 270, and an output roller 280 to advance cut print media 210 from system 200. In some examples, buffer 250 may be a particular size. For example, the particular size may correspond to a sum of the minimum buffer and the required additional buffer. The minimum buffer may be a constant value, or may vary based on plot length. For example, the minimum buffer may be between 20-40 mm in length. The required additional buffer may be an amount of buffer calculated by: multiplying the printing speed by the sum of the time needed to decelerate the media from the printing speed to stop the media, the time needed to accelerate the media from a stop to the printing speed, and the amount of time to cut the print media. In some examples, if the sum of the minimum buffer and the required additional buffer exceeds a maximum value, the particular size may be set to be the maximum value. Additionally, in some examples, buffer 250 may be generated by feed roller 230 at buffer start position 255. Since print media 210 may be consistently moving, buffer start position 255 may pass through drive roller 240 before buffer 250 is fully generated. Thus, buffer start position 255 need not always be part of the portion of print material 210 between feed roller 230 and drive roller 240.

In this example, print media 210 may enter printing system 200 from an upstream media path by being extracted from a supply roll and transported to feed roller 230. Print media 210 may be extracted from the supply roll by a media transport system, which may include feed roller 230 or may be separate and distinct from feed roller 230. For example, the media transport system may include at least one roller, start wheel, drum, and/or belt. While in the example shown in FIG. 2, print media 210 passes cutting system 220 before being advanced to feed roller 220, implementations consistent with disclosed examples need not pass cutting system 220 before being advanced to feed roller 230.

In the example shown in FIG. 2, feed roller 230 may be located upstream from drive roller 240 and may function to progressively generate buffer 250 between itself and drive roller 240. For example, feed roller 230 may initially operate at an initial speed. When the portion of print media 210 corresponding to a buffer start position engages with feed roller 230, the feed roller may progressively (e.g., gradually) increase its speed to advance print media 210 at a buffer generation speed calculated by a buffer generation system (which in this example may or may not be part of printing system 200). By accelerating print media 210 through feed roller 230 at the buffer generation speed, feed roller 230 may accumulate a portion of print media 210 between feed roller 230 and drive roller 240 to generate or otherwise create buffer 250. For example, the buffer generation speed may be greater than the printing speed, below a maximum feed speed (e.g., a maximum speed by which the feed roller may feed print media 210 to drive roller 240), and calculated separately for each plot based on the printing speed, a length of the plot to be printed, and/or a minimum buffer an example calculation is discussed in greater detail below with respect to, for example, FIG. 4). Thus, in some implementations, feed roller 230 may advance print media 210 at a higher rate than drive roller 240 advances print media 210 to print zone 260, and buffer 250 may be a loop of print media 210 stored between feed roller 230 and drive roller 240.

In some examples, printing system 200 may control the size of butter 250 by changing the relative speeds at which feed roller 230 and/or drive roller 240 advance print media 210. In an example, a speed at which the feed roller advances the print media 210 is controlled relative to the speed at which the drive roller 240 advances the media to print zone to control the amount of print media 210 collected in the region between the feed roller 230 and the drive roller 240. For example, where the teed roller 230 is upstream from drive roller 240, the speed at which the feed roller 230 advances the print media 210 is progressively (e.g., gradually) increased when more buffer is needed (i.e. when the buffer is close to being empty) and decreased when less buffer is needed (i.e. when the buffer is close to the maximum buffer size). By progressively forming this loop of print media 210 instead of forming the loop of print media 210 at a maximum feed speed at a static point in print media 210 corresponding to the plot, print system 200 may effectively mechanically decouple a portion of print media 210 in print zone 260 from the remainder of the substrate in the upstream media path. This prevents forces directed towards or away from the upstream portion of print media 210 from pushing or pulling on the region of print media 210 in print zone 260.

Once buffer 250 reaches a particular size, teed roller 230 may decelerate and/or stop advancing print media 210. For example, feed roller 230 may stop advancing print media 110 in response to completing generating the buffer. After the print media has stopped advancing, cutting system 220 may cut print media 210. Cutting system 220 may be any component or collection of components suitable to cut print media 210. For example, cutting system 220 may be a linear blade with a rotator blade module guided and motorized with the help of a cable. Once the media has been cut, feed roller 230 may accelerate print media 210 at the feed speed to begin creation of a new buffer, while the current buffer 250 is advanced by teed roller 240 to print zone 260 to be printed on by print device 260 and ultimately ejected from print system 200 by output roller 280 (or any other component or collection of components suitable for ejecting cut media from print system 200). Thus, buffer 250 may exit the area between the feed roller 230 and drive roller 240 while feed roller 230 begins generating a new buffer. Thus, printing system 200 may ensure that there is always a minimum buffer between feed roller 230 and drive roller 240 during the continuous printing process. Accordingly, this may ensure that there is little to no tension in the media while printing device 270 prints on print media 210, and that there are no changes in the media direction that could affect image quality. In other words, while print media 210 is in print zone 260, the movement of the media effectively functions as a single sheet.

In some examples, print system 200 may include a sensor (not shown in FIG. 2) that determines when the buffer has been generated to be a particular size. For example, in some implementations print system 200 may include a sensor between feed roller 230 and drive roller 240. For example, the sensor may be arranged to detect the extent by which print media 210 forms a loop between feed roller 230 and drive roller 240. For example, the sensor may be arranged between the feed roller and the drive roller and/or may provide a signal to printing system 200 when the amount of buffer is at a minimum level and to provide another signal to print system 102 when the buffer is at a maximum level. As another example, the sensor may be arranged to provide a signal to printing system 200 when the amount of buffer is at a particular size. As another example, the sensor can be used to ensure a minimum buffer until the buffer start position engages with feed roller 230 to generate buffer 250 at the buffer generation speed. For example, the sensor may be used by a buffer generation system (e.g. feed roller 230) to modify the buffer generation speed (at least temporarily) to ensure a minimum buffer until the buffer start position engages with the buffer generation system. The sensor may be any suitable sensor, such as a photoelectric (optical) sensor, an ultrasonic sensor, or any other sensor that can detect a size of the buffer.

Drive roller 240 may function to advance print media 210 through print zone 260 at a printing speed such that it can be printed on by printing device 270. In the example shown in FIG. 2, drive roller 240 may be located downstream from feed roller 230 and upstream from printing device 270. Printing device 270 may be any suitable printing device capable of printing text and/or graphics onto print media 210. For example, printing device 270 may be at least one print nozzle, print bar, print head, and/or any other suitable type of printing element. Once printing is complete, the cut print media 210 may exit the system via output roller 280.

FIG. 3 is a flow chart of an example process 300 for progressively generating a buffer consistent with disclosed implementations. Although execution of process 300 is described below with reference to panting system 100 of FIG. 1 and/or specific components of printing system 100, other suitable systems and devices for execution of at least one step of process 300 may be used. For example, processes described below as being performed by printing system 100 may be performed by printing system 200 and/or any other suitable device. Process 300 may be implemented in the form of executable instructions stored on a storage device, such as a machine-readable storage medium, and/or in the form of electronic circuitry.

Process 300 may start (step S305) when print media has been advanced to a print zone. For example, the print media may be extracted from a supply roll and transported by drive system 110 to the print zone. Once the print media has been advanced to the print zone, process 300 may include feeding the print media through the print zone (step 310). For example, the print media may be fed continuously through the print zone using drive system 110 (e.g., a drive roller) at a printing speed (step S310). While at the print zone, the print media may continue to move at the printing speed while a print device continuously prints on the print media.

Process 300 may also include feeding the print media through a buffer generation system (step S320) at a particular speed, such as the printing speed. For example, the print media may be advanced through buffer generation system 130 at a particular speed, such as the printing speed, until the media reaches drive system 110. Once the media engages with (e.g., arrives at) drive system 110, a buffer speed calculation system, such as buffer speed calculation system 120, may calculate a buffer generation speed. For example, buffer speed calculation system 120 may dynamically calculate a buffer generation speed for each plot to be printed. Thus, the buffer generation speed for buffer generation system 130 may differ for each plot to be printed. In some implementations, the buffer calculation system 120 may dynamically calculate (e.g., calculate for each plot to be printed) the buffer generation speed based on the printing speed, a length of the particular plot to be printed, a minimum buffer, a buffer start position, and an amount of time required to cut the print media. Additionally, the buffer generation speed may be below a maximum buffer generation speed and greater than the printing speed. In some examples, buffer calculation system 120 may calculate the buffer generation speed by determining a feed speed by dividing an amount of print media available to create the buffer by an amount of time needed to create the buffer and adding the feed speed to the printing speed. An example of these processes are described in greater detail below with respect to, for example, FIG. 4.

Process 300 may also include accelerating the print media through the buffer generation system at the buffer generation speed to create the buffer (step 3330). For example, before the print media is fed through the buffer generation system at the buffer generation speed, the print media is advancing at the particular speed describe above with respect to step S320. If the plot length is exceeds a predetermined plot length (e.g., a maximum plot length), buffer generation system 130 may continue to advance the print media at the particular speed for a particular amount of time. In other words, buffer generation system 130 may delay creating the buffer (e.g. feeding the print media through the buffer generation system 130 at the buffer generation speed) if the length of the plot to be printed exceeds a predetermined length, creating a new buffer start position. Once the new buffer start position reaches buffer generation system 130 (e.g., the leading edge engages with buffer generation system 130), controller 140 may accelerate the print media through the buffer generation system at the buffer generation speed to create a buffer between the buffer generation system and the drive system. For example, controller 140 may advance the print media at the buffer generation speed when the buffer start position engages with the buffer generation system. The buffer generation speed may be calculated by determining a feed speed by dividing an amount of the print media available to create the buffer by an amount of time needed to create the buffer; and adding the feed speed to the printing speed. After the buffer has been created (e.g., once the buffer needed is achieved), buffer generation system 120 may decelerate (step S340) and ultimately stop. When buffer generation system 120 stops, the print media may continue to be fed through drive system 110 at the printing speed and a print device may print the plot on the print media as the print media passes through the print zone. For example, controller 140 of system 100 may stop buffer generation system 130 when the buffer reaches a particular size. After the buffer generation system 120 has decelerated, process 300 may end (step S355) and other processes may be performed. For example, while the plot is being printed, and after the buffer generation system has been stopped, a cutting system may cut the print media. In some examples, the print device may print the plot on the print media during the cutting. In some examples, the cutting system may cut the print media such that there is an amount of buffer remaining in the system. For example, the buffer may be generated to include the minimum buffer as well any required additional buffer that is needed to reduce to eliminate media tension and/or not substantially alter the direction of movement of the print media. After the media has been cut, the system may begin advancing the print media to the drive roller, and begin generating a new buffer. After the plot is printed, the printed media including the plot is ejected as a single sheet.

FIG. 4 is a flow chart of an example process 400 or calculating a buffer generation speed consistent with disclosed implementations. Although execution of process 400 is described below with reference to printing system 100 of FIG. 1 and/or specific components of printing system 100, other suitable systems and devices for execution of at least one step of process 400 may be used. For example, processes described below as being performed by printing system 100 may be performed by printing system 200 and/or any other suitable device. Process 400 may be implemented in the form of executable instructions stored on a storage device, such as a machine-readable storage medium, and/or in the form of electronic circuitry.

Process 400 may start (step S405) after system 100 receives data related to the plot to be printed. For example, process 400 may start after a print device begins advancing the print media to print the plot. In some implementations, process 400 may include determining an amount of print media available to create a buffer between the buffer generation system (e.g., the entry of a buffer generation system) and a drive system (step S410). For example, the buffer may be a particular size based on the sum of a minimum buffer and the required additional buffer. In some examples, the required additional buffer may he based on the printing speed and a time required to cut the print media.

In some implementations, buffer generation system 130 may determine the amount of print media available to create the buffer by determining the plot length of the plot to be printed and subtracting the distance between a cutting system 220 and buffer start position 255. In some examples, the printer may continually advance the print media at a printing speed through a print zone Additionally, in some examples, the amount of media is based on a plot length and is greater than or equal to a minimum buffer and less than or equal to a maximum buffer. For example, system 100 may determine an amount of media that exits buffer generation system 120 while buffer generation system 120 is stopped to cut the buffer, and the amount of print media that exited the buffer generation system while the buffer generation system is decelerating to stop, the amount of media that exited the loop while the print media is stopped to cut, the amount of print media that exited to accelerate the expulsion of the media and add those values together. For example, the time to cut the print media may be known and/or may otherwise be constant. Furthermore, the acceleration and/or deceleration of the print media may be defined. Based on this, system 100 may calculate the amount of media the exits the buffer generation system 120.

Process 400 may also include determining an amount of time needed to create the buffer (step S420). In some implementations, system 100 may determine an amount of time needed to create the buffer, the amount of time being based on the amount of print media available to create the buffer, the printing speed, and an amount of time required to decelerate the buffer generation system to advance the print media continuously through the print zone at the printing speed. For example, system 100 may determine the amount of time needed to create the buffer by dividing the amount of print media available to create the buffer by the printing speed, and subtracting one or more of the time to decelerate the print media to stop it, the time to cut the media and the time to accelerate again the media up to the printing speed.

Process 400 may also include calculating a buffer generation speed based on the printing speed, the amount of print media available to create the buffer, and the amount of time needed to create the buffer. For example, system 100 may determine a feed speed by dividing the amount of material available to create the buffer by a feed speed time, the feed speed time being calculated by subtracting, from the amount of time needed to create the buffer, the sum of the time to decelerate the buffer generation system, a time to accelerate the buffer generation system to the printing speed, and an amount of time needed to generate the minimum buffer at the printing speed: and adding the feed speed to the printing speed. Thus in some examples, system 100 may calculate the buffer generation speed such that when the print media arrives at the print zone, the minimum buffer has already been generated. In other words, system 100 may generate the minimum buffer at the printing speed and generate the required additional buffer at the buffer generation speed. Additionally, in some examples, system 100 may calculate the amount of time needed to generate the minimum buffer by dividing the length of the minimum buffer by the printing speed. After the buffer generation speed has been calculated, process 400 may end (step S445).

The disclosed examples may include systems, devices, computer-readable storage media, and methods for progressive buffer generation. For purposes of explanation, certain examples are described with reference to the components illustrated in FIGS. 1A, 1B, and 2. The functionality of the illustrated components may overlap, however, and may be present in a fewer or greater number at elements and components. Further, all or part of the functionality of illustrated elements may co-exist or be distributed among several geographically dispersed locations. Moreover, the disclosed examples may be implemented in various environments and are not limited to the illustrated examples.

Moreover, as used in the specification and the appended claims, the singular forms “a,” “an,” and “the” are intended to include the plural forms as well, unless the context indicates otherwise. Additionally, although the terms first, second, etc. may be used herein to describe various elements, these elements should not be limited by this terms. Instead, these terms are only used to distinguish one element from another.

Further, the sequence of operations described in connection with FIGS. 1A-4 are examples and are not intended to be limiting. Additional or fewer operations or combinations of operations may be used or may vary without departing from the scope of the disclosed examples. Thus, the present disclosure merely sets forth possible examples of implementations, and many variations and modifications may be made to the described examples. All such modifications and variations are intended to be included within the scope of this disclosure and protected by the following claims.

We claim:

1. A printing system comprising:
a drive system to advance print media through a print zone at a printing speed;
a buffer speed calculation system to calculate a buffer generation speed based on the printing speed, a length of a plot to be printed, a minimum buffer, a buffer start position and an amount of time required to cut the print media; and
a buffer generation system to generate a buffer between the buffer generation system and the drive system, the buffer being generated by advancing the print media at the buffer generation speed to accumulate a portion of the print media between the drive system and the buffer generation system.

2. The printing system of claim 1, wherein the buffer speed calculation system calculates the buffer generation speed such that when the print media arrives at the print zone, the minimum buffer has already been generated.

3. The printing system of claim 1, wherein:
the buffer speed calculation system is to calculate the buffer start position, the buffer start position being based on the length of the plot to be printed;
the buffer generation speed is based on a sum of the minimum buffer and a required additional buffer, the required additional buffer being based on the printing speed and a time required to cut the print media; and
the drive system continuously advances a first portion of the print media at the printing speed while the buffer generation system advances a second portion of the print media at the buffer generation speed.

4. The printing system of claim 1, further comprising:
a controller to coordinate a speed of the buffer generation system, wherein:
the buffer start position is a position on the print media;
the controller advances the print media at the buffer generation speed when the buffer start position engages with the buffer generation system; and
the controller stops the buffer generation system when the buffer reaches a particular size.

5. The printing system of claim 4, wherein:
the buffer generation system includes a feed roller; and
a speed of the roller may progressively increase to advance the print media at the buffer generation speed.

6. The printing system of claim 4, wherein the particular size greater than or equal to the minimum buffer, is less than or equal to the maximum buffer, and is based on a sum of the minimum buffer and the required additional buffer.

7. The printing system of claim 1, further comprising a cutting system to cut the print media after the buffer is generated,
wherein the buffer generation system is to stop advancing the print media in response to completing generating the buffer, and
the cutting system is to cut the print media after the print media has stopped advancing.

8. The printing system of claim 7, wherein the buffer speed calculation system calculates the buffer generation speed based on an amount of media available to create the buffer and an amount of time needed to create the buffer.

9. The printing system of claim 7, wherein:
the minimum buffer is minimum amount of buffer needed after cutting to isolate the print zone from media tension; and
the maximum buffer is the maximum buffer length that will fit inside a print device associated with the print zone.

10. The printing system of claim 1, wherein the buffer generation system is to modify the buffer start position if the length of the plot to be printed is greater than a predetermined number and to modify the buffer generation speed to ensure a minimum buffer until the buffer start position engages with the buffer generation system.

11. A method comprising:
continuously feeding a print media through a print zone using a drive roller, the print media been fed through the print zone at a printing speed;
feeding the print media through a buffer generation system at the printing speed;
accelerating the print media through the buffer generation system at a buffer generation speed to create a buffer between the buffer generation system and the drive roller, the buffer generation speed being:
calculated based on the printing speed, a length of a plot to be printed, and a minimum buffer;
below a maximum buffer generation speed; and
greater than the printing speed: and
decelerating the buffer generation system after the buffer is created.

12. The method of claim 11, comprising:
delaying creating the buffer if the length of the plot to be printed exceeds a predetermined length;
stopping the buffer generation system after the buffer is created;
cutting the print media after the buffer generation system is stopped; and
printing the plot on the print media during the cutting.

13. The method of claim 11, comprising:
calculating the buffer generation speed, the buffer generation speed being calculated by:
determining a feed speed by dividing an amount of the print media available to create the buffer by an amount of time needed to create the buffer; and
adding the feed speed to the printing speed.

14. A non-transitory computer-readable storage medium including instructions which, when executed be a processor, cause the processor to:
determine an amount of print media available to create a buffer between a buffer generation system and a drive system that continually advances the print media at a printing speed through a print zone, the amount of media being based on a plot length and being greater than or equal to a minimum buffer and less than or equal to a maximum buffer;
determine an amount of time needed to create the buffer, the amount of time being based on the amount of print media available to create the buffer, the printing speed, and an amount of time required to decelerate the buffer generation system to advance the print media continuously through the print zone at the printing speed; and
calculate the buffer generation speed based on the printing speed, the amount of print media available to create the buffer, and the amount of time needed to create the buffer.

15. The computer-readable storage medium of claim 14, wherein the buffer generation speed is calculated by:
determining a feed speed by dividing the amount of print media available to create the buffer by a feed speed time, the feed speed time being calculated by subtracting, from the amount of time needed to create the buffer, the sum of the time to decelerate the buffer generation system, a time to accelerate the buffer generation system to the printing speed, and an amount of time needed to generate the minimum buffer at the printing speed; and
adding the feed speed to the printing speed.
For example, system 100 may determine a feed speed by dividing the amount of material available to create the buffer by a feed speed time, the feed speed time being calculated by subtracting, from the amount of time needed to create the buffer, the sum of the time to decelerate the buffer generation system, the time to accelerate the buffer generation system, and the time needed to generate the minimum buffer at the printing speed; and adding the feed speed to the printing speed
